(19) United States
(12) Patent Application Publication
(10) Pub. No.: US 2016/0109978 A1
(43) Pub. Date: Apr. 21, 2016

(54) MOBILE DEVICES, ELECTRONIC DEVICES AND METHODS FOR ACTIVATING APPLICATIONS THEREOF

(71) Applicant: Acer Incorporated, New Taipei City (TW)

(72) Inventors: Hsing-Lung CHUNG, New Taipei City (TW); Chueh-Pin KO, New Taipei City (TW)

(21) Appl. No.: 14/794,133

(22) Filed: Jul. 8, 2015

(30) Foreign Application Priority Data
Oct. 16, 2014 (TW) 103135782

(51) Int. Cl. G06F 3/044

(52) U.S. Cl. CPC G06F 3/044

(57) ABSTRACT

A mobile device is provided with a touch panel and a processing unit. The touch panel includes one or more signal transmitting units and signal receiving units for sensing the nearness or contact of an electronic device having capacitive touch sensing functionality. The processing unit obtains a predetermined pattern signal according to a currently executed application, generates a transmitting signal with a signal energy matched with a predetermined energy requirement based on the predetermined pattern signal, and transmits the transmitting signal containing the predetermined pattern signal to the electronic device via the signal transmitting unit, so as to activate the respective application on the electronic device using the predetermined pattern signal.

### CROSS REFERENCE TO RELATED APPLICATIONS

This Application claims priority of Taiwan Application No. 103135782, filed on Oct. 16, 2014, the entirety of which is incorporated by reference herein.

### FIELD OF THE INVENTION

The invention relates to application activation techniques, and more precisely, to mobile devices, electronic devices, and methods for activating applications thereof capable of enabling one device to activate a respective application of another device using touch-transmission techniques.

### DESCRIPTION OF THE RELATED ART

In recent years, portable devices, such as handheld devices, have been more and more technically advanced and versatile. For example, a handheld device may have: telecommunications capabilities, with the ability to receive e-mail messages; built-in phone book software with advanced management applications that allows multimedia playback; and a variety of other functions. These multifunctional devices bring convenience, but they also make themselves indispensible in the day-to-day lives of their users.

Some handheld devices, such as smartphones, personal digital assistants (PDAs), Tablet PCs (Tablet PCs) or ultra-portable PCs (UMPC, Ultra Mobile PC), are equipped with a touchable touch screen to be used as the primary input device. Users of these handheld devices can touch the touch-sensitive display by means of options displayed on the handheld device to give commands to execute or control the functions represented by said option. For example, the user can click a draw button or an icon on a touchable touch screen to launch a drawing function, or click the navigation button or icon on the display device to activate a satellite navigation application.

As users' needs change, people may choose to have many portable devices, most of which may be operated via a touch screen. However, it is not yet possible for a device to retrieve information from another device by detecting touch signals between two devices; neither is it possible to reduce interference between the devices. For example, when a mobile phone is placed on a tablet, certain areas of the tablet may not be operable.

### BRIEF SUMMARY OF THE INVENTION

Mobile devices, electronic devices and methods for activating applications thereof capable of enabling one device to activate a respective application of another device using touch-transmission techniques are provided.

In a first aspect of the invention, a mobile device is provided. The mobile device comprises a touch panel and a processing unit. The touch panel includes one or more signal transmitting units and signal receiving units for sensing proximity or contact of an electronic device having a capacitive touch sensing functionality. The processing unit is arranged for obtaining a predetermined pattern signal according to a currently executed application, generating a transmitting signal with a signal energy matched with a predetermined energy requirement based on the predetermined pattern signal, and transmitting the transmitting signal containing the predetermined pattern signal to the electronic device via the signal transmitting unit, so as to activate a respective application of the electronic device using the predetermined pattern signal.

In a second aspect of the invention, an electronic device is provided. The electronic device comprises a touch panel and a processing unit. The touch panel comprises at least one signal transmitting unit and at least one signal receiving unit for sensing a proximity or contact of a mobile device having a capacitive touch sensing capability. The processing unit is configured to detect a signal variation on the touch panel via the signal receiving unit in response to the detection of nearness or contact of the mobile device, determine whether the signal variation matches a predetermined energy requirement and whether a predetermined pattern signal is detectable in the signal variation, and if so, establish a connection with the mobile device and activate a respective application associated with the predetermined pattern signal.

In a third aspect of the invention, a method for activating applications executed by a mobile device is provided, wherein the mobile device and an electronic device are close to or in contact with each other, each of which is equipped with a respective touch panel comprising at least one signal transmitting unit and at least one signal receiving unit, wherein the mobile device performs signal transmission and reception using a touch-transmission technology via the signal transmitting unit and the signal receiving unit, respectively, and the electronic device performs signal transmission and reception using the touch-transmission technology via the signal transmitting unit and the signal receiving unit, respectively. The method for activating applications comprises the steps of: obtaining, by the mobile device, a predetermined pattern signal according to a currently executed application and generating a transmitting signal with a signal energy matched with a predetermined energy requirement based on the predetermined pattern signal; and transmitting, by the mobile device, the transmitting signal containing the predetermined pattern signal to the electronic device using the touch-transmission technology via the signal transmitting unit, so as to activate a respective application of the electronic device using the predetermined pattern signal.

In a fourth aspect of the invention, a method for activating applications executed by an electronic device is provided, wherein the electronic device and a mobile device are close to or in contact with each other, each of which is equipped with a respective touch panel comprising at least one signal transmitting unit and at least one signal receiving unit, wherein the mobile device performs signal transmission and reception using a touch-transmission technology via the signal transmitting unit and the signal receiving unit, respectively, and the electronic device performs signal transmission and reception using the touch-transmission technology via the signal transmitting unit and the signal receiving unit, respectively. The method for activating applications comprises the steps of: detecting, by the electronic device, a signal variation on the touch panel; determining, by the electronic device, whether the signal variation matches a predetermined energy requirement and whether a predetermined pattern signal is detectable in the signal variation; and if so, establishing, by the electronic device, a connection with the mobile device and activating a respective application associated with the predetermined pattern signal.

Other aspects and features of the present invention will become apparent to those with ordinary skill in the art upon review of the following descriptions of specific embodiments of the mobile devices and electronic devices for carrying out the methods for activating applications.

### BRIEF DESCRIPTION OF THE DRAWINGS

The invention can be more fully understood by reading the subsequent detailed description and examples with reference to the accompanying drawings, wherein:

FIG. 1 is a schematic diagram illustrating a mobile device according to an embodiment of the invention;

FIG. 2 is a schematic diagram illustrating an electronic device according to an embodiment of the invention;

FIG. 3 is a flow chart of the method for activating applications according to an embodiment of the invention;

FIG. 4 is a flow chart of the method for activating applications according to another embodiment of the invention;

FIG. 5A to FIG. 5C are schematic diagrams illustrating the operation flow of the content inter-transmission application between two devices according to embodiments of the invention; and

FIGS. 6A and 6B are schematic diagrams illustrating the operation flow of the device-interactive application between two devices according to embodiments of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

Embodiments of methods for activating applications of the present invention can be used to execute applications defined by a fixed pattern signal after the receiving end detects the fixed pattern signal through information transmission through contact of touch panels of two portable devices at the transmitting end and the receiving end when the user operates a mobile device such as a mobile phone or a tablet.

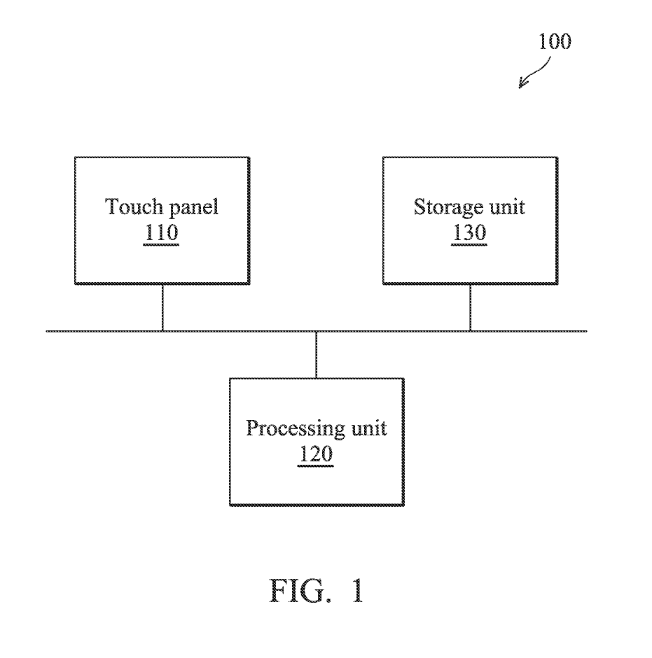

FIG. 1 is a schematic diagram illustrating a mobile device according to an embodiment of the invention. The mobile device 100 comprises a touch panel (also called a capacitive touch sensitive panel) 110, a processing unit 120, and a storage unit 130. The mobile device 100 may be a mobile phone, smartphone, wearable device (e.g., glasses, or a watch), panel PC, Portable Media Player (PMP), or portable gaming device.

The touch panel 110 may include a display device, such as a Liquid-Crystal Display (LCD), a Light-Emitting Diode (LED) display, or an Electronic Paper Display (EPD), for providing the display function. The touch panel 110 may further include one or more signal transmitting units (not shown) and signal receiving units (not shown) (which may be referred to as driving electrodes and sensing electrodes, respectively) disposed on or under the display device, for providing a touch-based Man-Machine Interface (MMI) by detecting the touch or proximity of a conductive object (e.g., a finger or touch pen) according to changes in the signals transmitted and received by the signal transmitting units and signal receiving units, respectively. In addition, with the signal transmitting units and the signal receiving units, the mobile device 100 can also exchange information with another device having capacitive touch sensing functionality. To be more specific, the signal transmitting unit can be used to transmit specific signals when users use the touch-transmission technology on a capacitive sensing device (e.g., a capacitive sensing device, a smartphone or a capacitive sensing device without a display). The content of specific signals may include signal energy, fixed signal patterns/texts, and/or the signal energy areas. Signal energy includes specific signals of a specific energy size, such as increasing the transmission voltage, so that the receiving end accepts stronger signals than usual. With fixed signal patterns/texts, signal patterns for use in a specific mode can be preset, such as to include, for example, Disney symbols, graphics by third parties, and so on, in the transmitting signal for subsequent use. The signal energy areas may display one interface on the touch panel in some applications to inform the user of the location of the receiving end to touch. In particular, the signal generation mode can be periodic generation. It should be understood that the user can activate the aforementioned functions through user interfaces and buttons.

The processing unit 120 may be a Central Processing Unit (CPU), Micro-Control Unit (MCU), Digital Signal Processor (DSP), or the like, which provides the function of data processing and computing. Specifically, the processing unit 120 may load and execute a series of instructions and/or program code from the storage unit 130 to control the operation of the capacitive touch panel 110 and obtain a predetermined pattern signal according to a currently executed application for performing the data transmission method of the invention. For example, the processing unit 120 may be the CPU of the mobile device 100, a controller within the touch IC, or a controller within the sensor hub integrating of all the sensing units.

The storage unit 130 may be a non-volatile memory (e.g., a Read-Only Memory (ROM), Flash memory, hard disc, optical disc, etc.), or it may be a volatile memory (e.g., a Random Access Memory (RAM)), or any combination thereof for storing signals and/or data. Specifically, the storage unit 130 may store a database used to store specific symbols. The database includes relevant APP or procedural information, corresponding signal patterns, and applicable information corresponding to signal patterns.

To be more specific, the processing unit 120 can detect applications or procedures currently in use. Based on the currently used APP or process detected, specific signal patterns can be generated. The processing unit 120 can generate specific signal patterns based on the built-in information inquiry AP/Process stored in storage unit 130, and specific signal patterns with the above-mentioned contents can be generated. After signals are generated, the capacitive touch panel 110 is converted into TX for transmission. The information containing specific signal patterns is transmitted to electronic device 200 through the signal transmission unit.

Although they are not shown, the mobile device 100 may further comprise other functional units, such as a Radio Frequency (RF) unit and a Baseband unit for wireless communications, and/or an Input/Output (I/O) device (e.g., button, keyboard, mouse, or touch pad, etc.), and the invention is not limited thereto. In one embodiment, if the mobile device 100 is a mobile phone or smartphone, the Baseband unit therein may contain multiple hardware devices to perform baseband signal processing, including ADC/DAC, gain adjusting, modulation/demodulation, encoding/decoding, and so on, while the RF unit therein may receive RF wireless signals, convert the received RF wireless signals to baseband signals, which are processed by the Baseband unit, or receive baseband signals from the baseband unit and convert the received baseband signals to RF wireless signals, which are transmitted later. The RF unit may also contain multiple hardware devices to perform radio frequency conversion, such as a mixer for multiplying the baseband signals with a carrier oscillated in the radio frequency of the wireless technology, wherein the radio frequency may be 900 GHz, 1800 GHz, or 1900 GHz utilized in the Global System for Mobile communications (GSM) technology, or may be 900 GHz, 1900 GHz, or 2100 GHz utilized in the Wideband Code Division Multiple Access (WCDMA) technology, or others depending on the wireless technology in use.

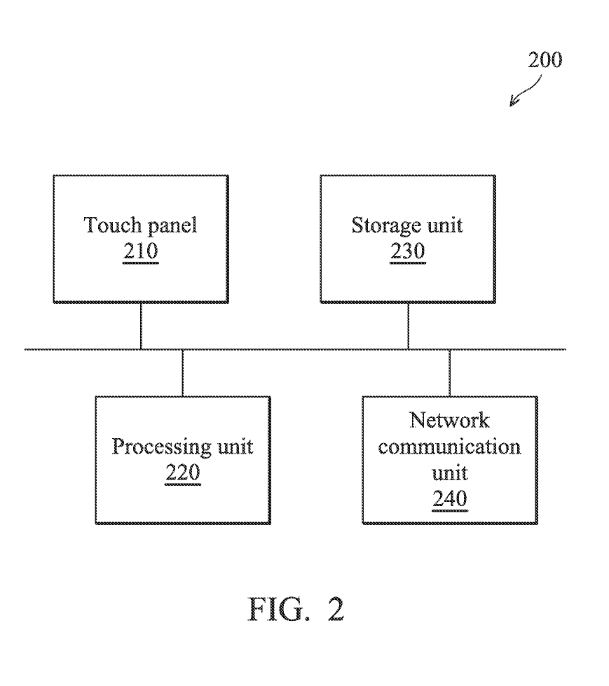

FIG. 2 is a schematic diagram illustrating an electronic device according to an embodiment of the invention. The electronic device 200 comprises a touch panel 210, a processing unit 220, a storage unit 230, and a network communication unit 240. The electronic device 200 may be a desktop computer, a panel PC, a notebook, a tablet, an touch TV or an electronic device similar to the mobile device 100, such as a mobile phone, a smartphone, a tablet or the like.

The touch panel 210 may include one or more signal transmitting units (not shown) and signal receiving units (not shown) (which may be referred to as driving electrodes and sensing electrodes, respectively) disposed on or under the display device, for providing a touch-based Man-Machine Interface (MMI) by detecting the touch or proximity of a conductive object (e.g., a finger or touch pen) according to changes in the signals transmitted and received by the signal transmitting units and signal receiving units, respectively. In addition, with the signal transmitting units and the signal receiving units, the touch panel 210 can also exchange information with another device other than the electronic device 200 having a capacitive touch sensing functionality. To be more specific, the signal receiving unit can receive information transmitted by the mobile device 100 when it detects that the mobile device 100 is in physical contact or nearby.

The processing unit 220 may be a Central Processing Unit (CPU), Micro-Control Unit (MCU), Digital Signal Processor (DSP), or the like, which provides the function of data processing and computing. Specifically, the processing unit 220 may load and execute a series of instructions and/or program code from the storage unit 230 to control the operation of the touch panel 210 and the network communication unit 240 for performing the data transmission method of the invention. For example, the processing unit 220 may be the CPU of the electronic device 200, a controller within the touch IC, or a controller within the sensor hub integrating of all the sensing units. To be more specific, the processing unit 220 may parse received signals and perform respective applications based on the parsed signals. In some embodiments, the respective applications may include: networking operations. For example, the specific signals may represent a specific network link and allow users to connect to App store through the Internet and download contents (such as e-books, games, movies, etc.) after paying a fee on the webpage. In other embodiments, the respective applications may include: the inter-transmission of contents from one device to another (such as music, movie, photo file translfer or the like between two devices). In some embodiments, the respective applications may include: cloud downloads (such as cloud content downloads). Details of the respective applications will be described in the following paragraphs.

The processing unit 220 may determine the respective applications based on signal contents received by the signal receiving unit. In particular, determination of the respective applications based on signal contents received by the signal receiving unit may include determining whether the energy variation of signals received by the touch panel matches a transmission requirement. The following conditions must be met: the energy variation of signals received should match the time and size of the energy change of the transmission requirement; the signals received include specific pattern signals; and the signals received continue for a period of time and periodically appear.

When all the above-mentioned conditions are met, the processing unit 220 may cross compare specific pattern signals contained in signals received and the database established. Comparison of the database may include comparing the built-in database of the storage unit 230 in this device and the remote database (such as the server or cloud database) in order to find corresponding applications and send corresponding instructions to applications in order to activate respective applications.

The storage unit 230 may be a non-volatile memory (e.g., a Read-Only Memory (ROM), Flash memory, hard disc, optical disc, etc.), or it may be a volatile memory (e.g., a Random Access Memory (RAM)), or any combination thereof for storing signals and/or data. Specifically, the storage unit 230 may store a database used to store data, such as the storage of one predetermined database. The predetermined database may include records of multiple sets of predetermined pattern signals and corresponding applications.

The network communication unit 240 is responsible for providing the function of wired or wireless network access, so that the electronic device 200 may connect to the Internet or a particular server set up on the Internet. The wired network access may include an Ethernet connection, an Asymmetric Digital Subscriber Line (ADSL), a cable connection, or the like. The wireless network access may include a connection to a Wireless Local Area Network (WLAN), a WCDMA system, a Code Division Multiple Access 2000 (CDMA-2000) net system work, a Time Division-Synchronous Code Division Multiple Access (TD-SCDMA) system, a Worldwide Interoperability for Microwave Access (WiMAX) system, a Long Term Evolution (LTE) system, an LTE Advanced (LTE-A) system, or a Time-Division LTE (TD-LTE) system.

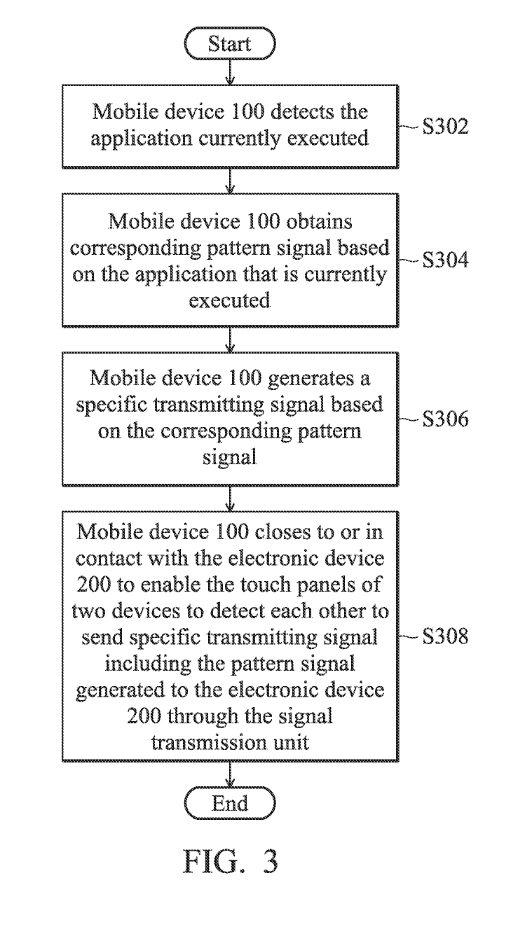

FIG. 3 is a flow chart of the method for activating applications according to an embodiment of the invention. In this embodiment, the method for activating applications is used in the mobile device 100 for interacting with the electronic device 200. Particularly, the mobile device 100 and the electronic device 200 both support the capacitive touch-sensing capability which enables exchange of information therebetween via the signal transmitting units and the signal receiving units. For example, in this embodiment, the method can be performed by the processing unit 120 of the mobile device 100.

First, when the user wants to share the content of an application currently executed (such as music, pictures, or video files) to the electronic device 200 (such as a tablet), the mobile device 100 (such as a mobile phone) may detect the application currently executed (step S302) and search for a record corresponding to the application currently executed in the database based on the application that is currently executed to obtain corresponding pattern signals (step S304) and generate a specific transmitting signal accordingly (step S306). For example, the storage unit 130 of the mobile device 100 may store one predetermined database. This predetermined database includes multiple applications or processes and records of corresponding predetermined pattern signals and applications. Therefore, the mobile device 100 may search corresponding records based on the application currently executing in the predetermined database to obtain respective patterns. In particular, the specific transmitting signal matches the time and size of predetermined energy change and includes the aforementioned corresponding pattern signals. For example (but not limited to), a specific portion of the transmission signals that have a higher signal energy than a predetermined value (such as the touch sensing signal points that have a voltage higher than that of typical touch sensing) may form the predetermined pattern signals. In another embodiment, the specific transmission signal can enable touch sensing signals in the edges of the touch panel to have signal strength higher than the predetermined value and enables touch sensing signals in the middle parts of the touch panel to have signal strength lower than the predetermined value.

Subsequently, the mobile device 100 may be close to or in contact with the electronic device 200 to enable the touch panels of two devices to detect each other and send specific transmission signals including the pattern signals generated, to the electronic device 200 through the signal transmission unit (step S308). Specifically, the touch panel of the mobile device may detect the proximity of the electronic device, and the touch panel of the electronic device 20 may also detect the proximity of the mobile device. For example, when the mobile device and the electronic device approach each other, the signals generated by the signal transmitting unit of the mobile device can be received by the signal receiving unit of the electronic device through electric field coupling. It should be noted that the mobile device 100 may periodically appear and continue for a period of time to transmit the specific transmission signal to the electronic device 200 through the signal transmission unit for the electronic device 200 to perform detection.

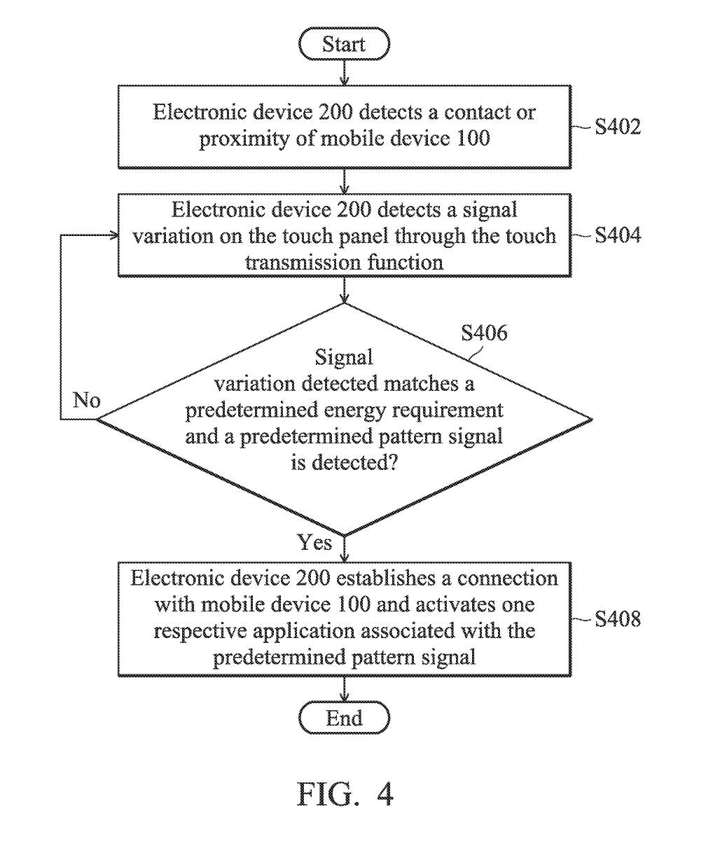

FIG. 4 is a flow chart of the method for activating applications according to another embodiment of the invention. In this embodiment, the method for activating applications is used in the electronic device 200 for interacting with the mobile device 100. For example, in this embodiment, the method can be performed by the processing unit 220 of the electronic device 200.

When the mobile device 100 is close to or in contact with the electronic device 200, the touch panels of two devices may be able to detect each other, thereby enabling the electronic device 200 to detect the contact or proximity of the mobile device 100 and detect a signal variation on the touch panel (step S404). Specifically, the signal receiving unit may receive signals transmitted by the mobile device 100 when detecting the proximity or contact of the mobile device 100.

Next, the electronic device 200 determines whether the signal variation detected matches a predetermined energy requirement and whether a predetermined pattern signal is detectable therefrom (step S406). In one embodiment, determination of whether the signal variation detected matches the predetermined energy requirement and whether the predetermined pattern signal is detectable therefrom may comprise: determining whether the signals detected match the time and size of energy variation, whether they periodically appear and continue for a period of time, and whether they belong to the predetermined pattern signals. In one embodiment, the above-mentioned determination may include whether the part of signal variation higher than the predetermined value (such as the touch sensing signal point having voltage higher than that of typical signal variation) forms the predetermined pattern signals. In another embodiment, the above-mentioned determination may include whether the signal variation enables the touch sensing signals in the edge part of the touch panel to have signal strength higher than a predetermined value and enables the touch sensing signals in the middle part of the touch panel to have a signal strength that is lower than the predetermined value, and if so, determine the time and size of matching the energy variation. When the signals detected match the time and size of the energy variation, show periodicity, continue to appear for a period of time, and belong to the predetermined pattern signals, the signal variation detected can be said to match the predetermined energy requirement and is capable of detecting the predetermined pattern signals. In particular, the determination of whether the signal variation detected belong to predetermined pattern signals may further comprise detecting a pattern signal from signals detected and finding a pattern signal matched from a predetermined database based on the detected pattern signal. If a match can be found in the database, the pattern signals detected are said to be the predetermined pattern signals.

When signal variation detected are determined as not matching the predetermined energy requirement or the predetermined pattern signal fails to be detected therefrom (No in step S406), the flow returns to step S402 to continue to detect signal variation. When the signal energy variation detected are determined as matching to the predetermined energy requirement and that the predetermined pattern signal can be detected (Yes in step S406), the electronic device 200 establishes a connection with the mobile device 100 and activates one respective application associated with the predetermined pattern signal (step S408). For example, the storage unit 230 of the electronic device 200 can be used to store one predetermined database. This predetermined database includes records of multiple predetermined pattern signals and corresponding applications. Therefore, the electronic device 200 can search related applications from the predetermined database based on the pattern signal to obtain information related to a respective application of predetermined pattern signals and link and activate the respective application based on the search results.

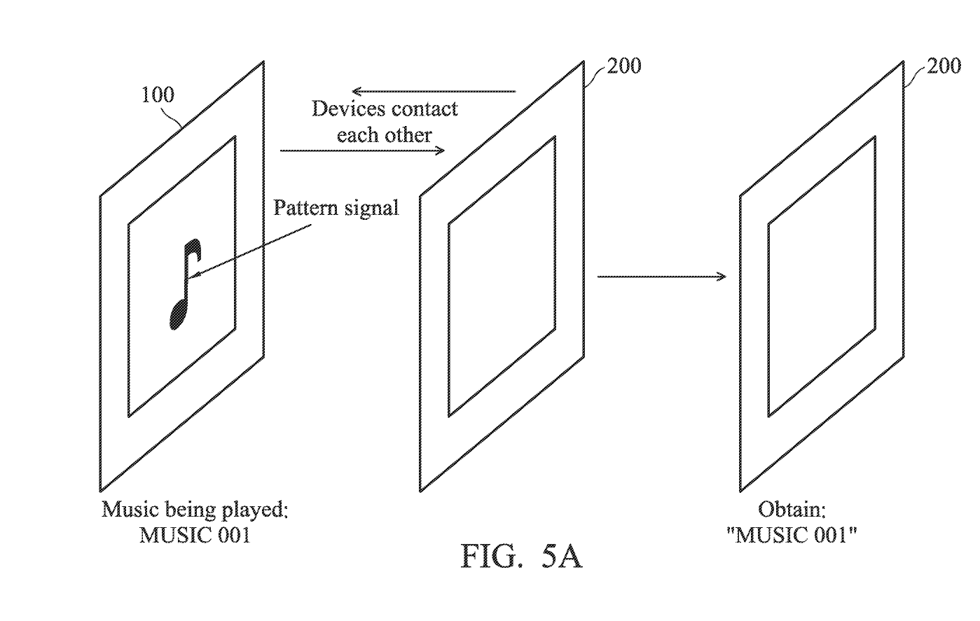

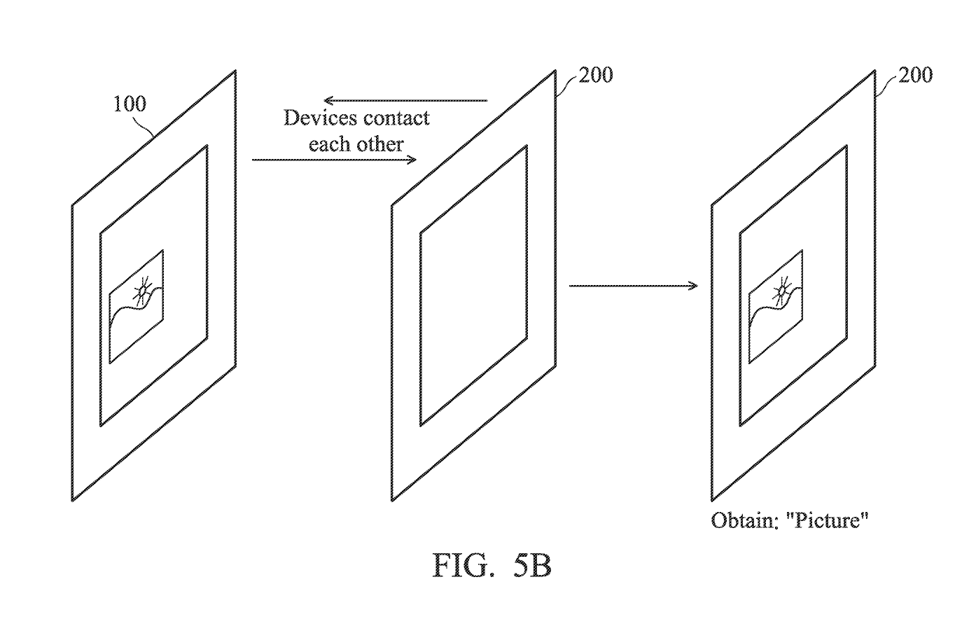

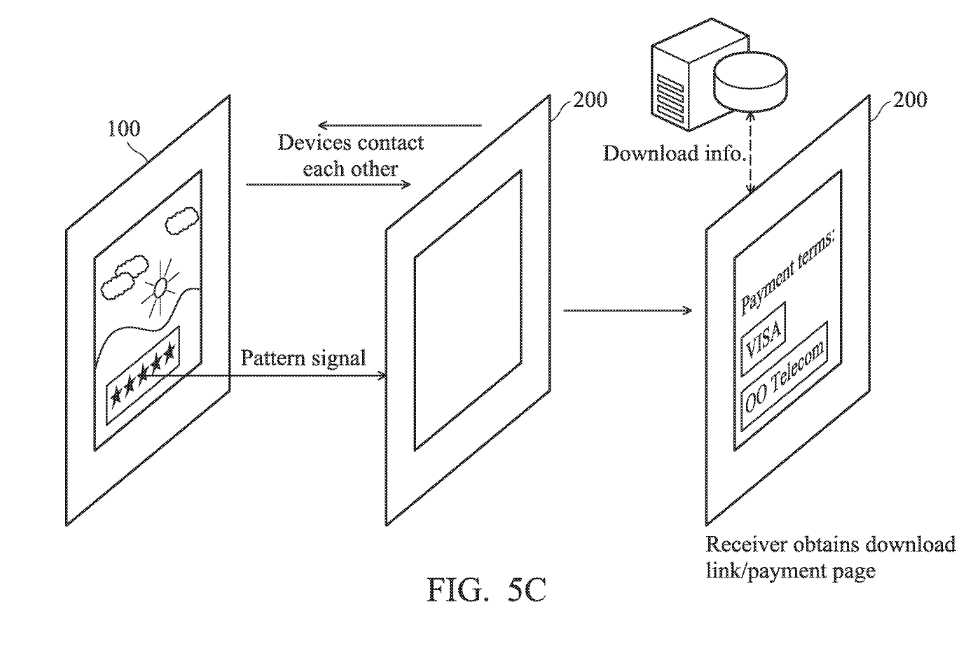

In some embodiments, the respective applications may include the inter-transmission of device contents (e.g. multimedia files, such as music, videos, and/or picture files transferred) between two devices. The step of activating one respective application associated with the predetermined pattern signal may include activating a content inter-transmission application to transmit media content currently being played to the electronic device 200 for playing in response to the predetermined pattern signal. In particular, the multimedia content may include music files, picture files, and/or video files. FIG. 5A to FIG. 5C are schematic diagrams illustrating the operation flow of the content inter-transmission application between two devices procedure according to embodiments of the invention. Taking the respective application being a music transfer application as example, as shown in FIG. 5A, when a mobile device 100 user is listening to music and wants to send music currently being played to the electronic device 200, the mobile device 100 at the transmission end can generate specific pattern signals (such as pattern signals of music symbols as shown in FIG. 5A and the signals are transmitted by bringing the two devices into contact. After the electronic device 200 at the receiving end receives the signals, it establishes a connection with the mobile device 100. The mobile device 100 may then be able to transmit the music currently being played to the electronic device 200. Similarly, in one embodiment, the front sides of the mobile device 100 and electronic device 200 can contact each other to activate the picture transfer application. After a connection is established, pictures currently being displayed on the mobile device 100 may be sent to the electronic device 200, as shown in FIG. 5B. In another embodiment, the front of the mobile device 100 and the front of the electronic device 200 can contact or face each other to activate the video transfer application. After a connection is established, the mobile device 100 may be able to share videos currently being played to the electronic device 200.

In some embodiments, respective applications may further include a network application. The activation of the respective application associated with the predetermined pattern signal may further include activating a networking application via a network link corresponding to the predetermined pattern signal and connecting to a server or a website for content downloading via the network communication unit 240. For example, the specific pattern signals may represent one network link that allows users to connect to a server or website such as the APP store through the network link on the Internet. Then, they can download contents (such as e-books, games, movies, etc.) available on the website after paying a fee. In some embodiments, one application is designed. When using the application, specific pattern signals are available in the background. When two devices are in contact, the receiving device that receives the signals can directly link to the payment-free/payment screen designated by the specific pattern signals, connect to relevant webpages or link to websites/physical online stores, and complete the link to download relevant contents, as shown in FIG. 5C. Then, links to online stores such as Tudou Network, Amazon VOD, Netflix, and so on can be established for users to download relevant content. In some embodiments, the electronic device 200 may be a large capacitive touch device set up in one specific place (such as a supermarket). It can provide the product catalogues, each product catalogue with its own pattern signals that enable users to download an exclusive application APP and obtain information such as prices and locations of models that interest them by touching the respective product catalogues.

In some embodiments, during the data transmission process, the sampling rate for transmission and reception of the touch panel can be controlled further to enhance efficiency. For example, if the device at the transmitting end wants to share a video file in order for the video file to be viewed at the receiving device, the bit rate of the video file is 5 Mbits/sec. If the current viewing method is direct streaming rather than offline download, the transmission per microsecond will be 5000000 bit/sec*sec/1000 ms=5000 bit/ms. If the transmission and reception time of the transmitting device and the receiving device are both 10 ms, and assuming the playback rate is also 50000 bit/10 ms, it means that, under the hardware limit, the transmitting device and the receiving device need to transmit and receive 50000 bit (5000 bit/ms*10) every 10 ms in order to ensure that the receiving device can view the streaming video smoothly. In another embodiment, assuming the video file size is 500 Mbits and the current viewing method is direct streaming, the transmission and receiving time are 10 ms and 8 ms respectively, every transmission and reception is 500 bit, and the time for the transmitting device to complete transmission and reception is (500*106/500*10=10000000 ms) and (500*106/500*8=8000000 ms), respectively. Then, the receiving device may need to pre-buffer about 2000000 ms (10000000−8000000) in order to ensure smooth subsequent viewing of the content. Therefore, when the corresponding application is the sharing or transfer of video files, the method of the invention can more appropriately control the sampling rate of the touch panel and the transmission rate, thereby increasing transmission and reception rates and achieving the goal for smooth viewing.

In the above-mentioned embodiment, when the electronic device at the receiving end requires synchronized viewing, the goal for smooth viewing can be achieved by increasing transmission and reception rates. On the other hand, when the user requires no live viewing, the transmission and reception rates can be decreased (such as sending content when the device is idle). Compared to high transmission and reception rates, this device is more energy efficient.

In the previous embodiment, after two devices are in contact and when the content inter-transmission application is activated through the specific pattern signal, data transmission between the mobile device 100 and the electronic device 200 can be done through the transmission and reception of signals on their touch panels. In some embodiments, when two devices are in contact and when the data transmission application is activated through the specific pattern signal, one dedicated communication protocol is used to transmit data. For example, when the data transmission application is activated, the transmitting device (such as the mobile device 100) can transmit a specific pattern signal representing that WIFI Direct technology is to be the communication protocol for transmission use to the receiving device at the receiving end (such as the electronic device 200). After the receiving device decodes the specific pattern signal, data transfer with the transmitting device can be initiated through the wireless direct connection protocol, thus accelerating the data transfer speed.

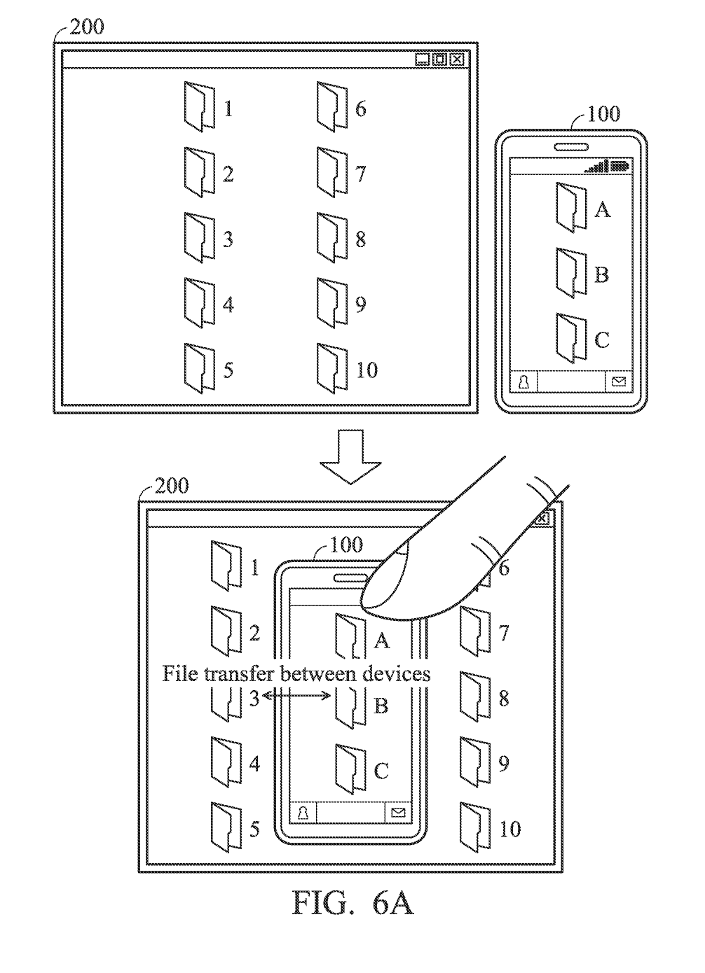

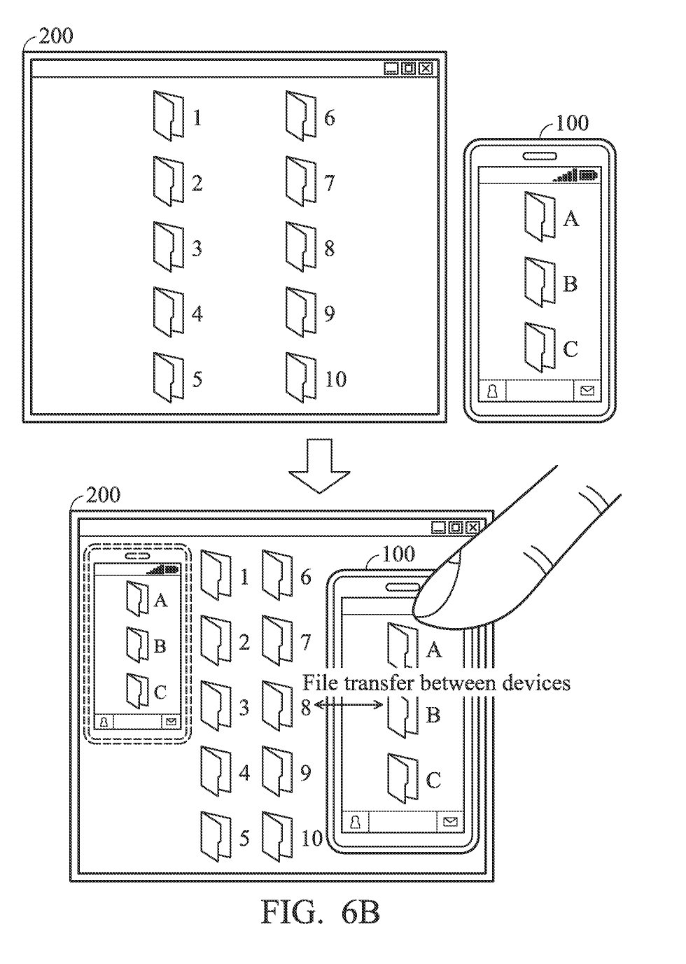

In some embodiments, the activation of the respective application associated with the predetermined pattern signal may further include activating a device-interactive application to use an application to detect an area on the electronic device 200 on which the mobile device 100 is placed, and readjust and rearrange the content of the operation screen of the electronic device 200 according to the area to transmit file between the mobile device 100 and the electronic device 200 or perform device interaction therebetween. For example, by detecting the specific area of the transmitting device (the mobile device 100) on the device at the receiving end (the electronic device 200), the operation screen at the receiving end is dynamically adjusted to facilitate user operation and ensure the screen is not blocked by the transmitting device and thus inoperable. FIGS. 6A and 6B are schematic diagrams illustrating the operation flow of the device-interactive application between two devices according to embodiments of the invention. In one embodiment, when the transmitting device and the receiving device overlap, the user interface (UI) of the two devices can be rearranged. For example, assuming the mobile device 100 is a mobile phone and the electronic device 200 is a tablet with a larger touch panel, when the mobile device 100 is placed on the electronic device 200, the electronic device 200 can detect the specific area of the mobile device 100, through which the operation screen of the electronic device 200 can be dynamically adjusted and the various locations of the items on the operation screen can be rearranged, thereby ensuring that the adjusted operation screen will not affect user operation. At the same time, based on the drag tracks, files can be transferred between the two devices, as shown in FIG. 6A. In this embodiment, specific pattern signals are established to identify the area range of the mobile device 100 in the electronic device 200 and activate the transfer application. In another embodiment, the operation screen of the small device can be directly represented on the large device. For example, as shown in FIG. 6B in the previous example, assuming the mobile device 100 is a mobile phone and the electronic device 200 is a tablet with a larger touch screen, when the mobile device 100 is placed on the electronic device 200, in addition to the operation screen of the electronic device 200 being dynamically adjusted, the operation screen of the mobile device 100 can be represented on the electronic device 200. When the user selects the operation screen of the mobile device 100 on the electronic device 200, the icon of the user interface that is currently being clicked can be returned to the mobile device 100 for identification and corresponding operations can be performed on the mobile device 100. Meanwhile, the operation screen window of the mobile device 100 on the electronic device 200 can be updated to ensure the interfaces of the two devices will not affect user operation. At the same time, more than two devices can be operated on the same screen, and the previous example can be conjunctively used to perform file transfer and interaction between the two devices, thereby enhancing convenience.

Therefore, according to the mobile devices, electronic devices and methods for activating applications thereof of the invention, the device at the transmission end can transmit predefined fixed pattern signals to the device at the receiving end when the device at the receiving end is contacted such that the device at the receiving end can perform applications defined by the fixed pattern signals after the predefined fixed pattern signals are detected to enable the user to achieve the purpose of obtaining content from both devices through the touch panels of the transmission end and the receiving end in contact, thereby not only simplifying the operation flow on the user device, but also matching the actual user operating requirements, and thus further providing a better user experience and convenience of use.

The embodiments of methods for activating applications that have been described, or certain aspects or portions thereof, may be practiced in logic circuits, or may take the form of program code (i.e., instructions) embodied in tangible media, such as floppy diskettes, CD-ROMS, hard drives, or any other machine-readable storage medium, wherein, when the program code is loaded into and executed by a machine such as a smartphone, a mobile phone, or a similar device, the machine becomes an apparatus for practicing the invention. The disclosed methods may also be embodied in the form of program code transmitted over some transmission medium, such as electrical wiring or cabling, through fiber optics, or via any other form of transmission, wherein, when the program code is received and loaded into and executed by a machine, the machine becomes an apparatus for practicing the invention. When implemented on a general-purpose processor, the program code combines with the processor to provide a unique apparatus that operates analogously to specific logic circuits.

While the invention has been described by way of example and in terms of preferred embodiment, it should be understood that the invention is not limited thereto. On the contrary, it is intended to cover various modifications and similar arrangements (as would be apparent to the skilled in the art). Therefore, the scope of the appended claims should be accorded the broadest interpretation so as to encompass all such modifications and similar arrangements.

What is claimed is:

1. A mobile device, comprising:
a touch panel, including one or more signal transmitting units and signal receiving units for sensing a proximity or contact of an electronic device having a capacitive touch sensing functionality; and
a processing unit, obtaining a predetermined pattern signal according to a currently executed application, generating a transmitting signal with a signal energy matched with a predetermined energy requirement based on the predetermined pattern signal, and transmitting the transmitting signal containing the predetermined pattern signal to the electronic device via the signal transmitting unit, so as to activate a respective application of the electronic device using the predetermined pattern signal.

2. The mobile device of claim 1, further comprising a storage unit for storing a predetermined database, wherein the processing unit further obtains the predetermined pattern signal according to the currently executed application by finding a matched pattern signal from the predetermined database according to the currently executed application, wherein the matched pattern signal is to be the predetermined pattern signal.

3. The mobile device of claim 1, wherein the processing unit further activates the respective application of the electronic device using the predetermined pattern signal by activating a content inter-transmission application to transmit media content currently being played to the electronic device for playing in response to the predetermined pattern signal.

4. The mobile device of claim 3, wherein the media content comprises an audio file, a picture file and/or a video file.

5. The mobile device of claim 3, wherein the processing unit further establishes a connection with the electronic device through a dedicated communication protocol and transmits the media content that is currently being played through the dedicated communication protocol after the content inter-transmission application is activated.

6. The mobile device of claim 1, wherein the processing unit further activates the respective application of the electronic device using the predetermined pattern signal by activating a device-interactive application to use an application to detect an area on the electronic device on which the mobile device is placed and readjusting and rearranging the content of an operation screen of the electronic device according to the area to transmit a file between the mobile device and the electronic device.

7. The mobile device of claim 1, wherein the transmitting signal is periodically and continually transmitted to the electronic device for at least a period of time.

8. An electronic device, comprising:
a touch panel, comprising at least one signal transmitting unit and at least one signal receiving unit for sensing a proximity or contact of a mobile device having a capacitive touch sensing capability; and
a processing unit, configured to detect a signal variation on the touch panel via the signal receiving unit in response to detection of nearness or contact of the predetermined energy requirement and whether a predetermined pattern signal is detectable in the signal variation, and if so, establish a connection with the mobile device and activate a respective application associated with the predetermined pattern signal.

9. The electronic device of claim 8, further comprising a network communication unit, wherein the processing unit further activates the respective application associated with the predetermined pattern signal by activating a networking application via a network link corresponding to the predetermined pattern signal and connecting to a server or a website for content downloading via the network communication unit.

10. The electronic device of claim 8, wherein the processing unit further activates the respective application associated with the predetermined pattern signal by activating a device-interactive application to use an application to detect an area on the electronic device on which the mobile device is placed and readjusting and rearranging the content of an operation screen of the electronic device according to the area to transmit file between the mobile device and the electronic device.

11. The electronic device of claim 10, wherein the step in which the processing unit activates the respective application associated with the predetermined pattern signal further comprises displaying an operation screen of the mobile device on an operation screen of the electronic device using the application in response to the predetermined pattern signal, such that the electronic device uses the operation screen of the mobile device displayed thereon to operate the mobile device.

12. The electronic device of claim 8, wherein the signal variation enables the touch sensing signals in the edge part of the touch panel to have signal strength higher than a predetermined value and enables the touch sensing signals in the middle part of the touch panel to have signal strength that is lower than the predetermined value.

13. The electronic device of claim 8, wherein the processing unit further determines whether the signal variation matches the predetermined energy requirement and whether the predetermined pattern signal is detectable in the signal variation signal by determining whether the signal variation detected matches time and size of energy change for the predetermined energy requirement and whether the signal variation detected periodically appears and continues for a period of time, and if so, determining that the signal variation matches the predetermined energy requirement.

14. A method for activating applications executed by a mobile device, wherein the mobile device and an electronic device are close to or in contact with each other, each of which is equipped with a respective touch panel comprising at least one signal transmitting unit and at least one signal receiving unit, wherein the mobile device performs signal transmission and reception using a touch-transmission technology via the signal transmitting unit and the signal receiving unit, respectively, and the electronic device performs signal transmission and reception using the touch-transmission technology via the signal transmitting unit and the signal receiving unit, respectively, the method comprising:
obtaining, by the mobile device, a predetermined pattern signal according to a signal energy matched with a predetermined energy requirement based on the predetermined pattern signal; and
transmitting, by the mobile device, the transmitting signal containing the predetermined pattern signal to the electronic device using the touch-transmission technology via the signal transmitting unit, so as to activate a respective application of the electronic device using the predetermined pattern signal.

15. A method for activating applications executed by an electronic device, wherein the electronic device and a mobile device are close to or in contact with each other, each of which is equipped with a respective touch panel comprising at least one signal transmitting unit and at least one signal receiving unit, wherein the mobile device performs signal transmission and reception using a touch-transmission technology via the signal transmitting unit and the signal receiving unit, respectively, and the electronic device performs signal transmission and reception using the touch-transmission technology via the signal transmitting unit and the signal receiving unit, respectively, the method comprising:
detecting, by the electronic device, a signal variation on the touch panel;
determining, by the electronic device, whether the signal variation matches a predetermined energy requirement and whether a predetermined pattern signal is detectable in the signal variation; and
if so, establishing, by the electronic device, a connection with the mobile device and activating a respective application associated with the predetermined pattern signal.

16. The method of claim 15, wherein the step of activating the respective application associated with the predetermined pattern signal further comprises activating a device-interactive application to use an application to detect an area on the electronic device on which the mobile device is placed and readjusting and rearranging the content of an operation screen of the electronic device according to the area to transmit file between the mobile device and the electronic device.

17. The method of claim 15, wherein the signal variation enables the touch sensing signals in the edge part of the touch panel to have signal strength higher than a predetermined value and enables the touch sensing signals in the middle part of the touch panel to have signal strength lower than the predetermined value.
